(19) United States
(12) Patent Application Publication
(10) Pub. No.: US 2009/0096616 A1
(43) Pub. Date: Apr. 16, 2009

(54) WARNING METHOD AND APPARATUS FOR REDUCING RISK OF DAMAGE TO PROJECTION DEVICE

(75) Inventor: CHEN-AN WU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/033,224

(22) Filed: Feb. 19, 2008

(30) Foreign Application Priority Data
Oct. 11, 2007 (CN) 200710202028.3

(51) Int. Cl. G08B 17/00

(52) U.S. Cl. 340/584

(57) ABSTRACT

An exemplary warning method for reducing the risk of damage to a projection device is disclosed. The warning method includes: establishing a predetermined performance threshold and a warning message; detecting a current performance value from the projection device; judging whether the detected current performance value exceeds the predetermined performance threshold; projecting the warning message.

### BACKGROUND

1. Technical Field

The invention relates to maintenance technology of projection devices, particularly to a warning method and apparatus for reducing the risk of damage to a projection device.

2. Description of Related Art

In general, projectors are equipped with a light emitting diode (LED) indicator for indicating a status of the projector, for example, a steadily lit LED indicates a normal status. A blinking LED indicates an abnormal status, thereby warning users to take action (e.g., turn off the projector, check vents of the projector for blockage, and/or replace the lamp of the projector). However, in practice, the users may not notice the LED indicator, since they are focusing on what is projected by the projector, even though, typically, LED indicators are located on the surface (e.g., top surface) of the projector not easily alert the users when the users are focusing on the projected images.

Therefore, it is desirable to provide a warning method and apparatus for reducing the risk of damage to a projection device, which can overcome the above mentioned problem.

### SUMMARY

In a present embodiment, a warning method for reducing the risk of damage to a projection device is disclosed. The warning method includes: establishing a predetermined performance threshold and a warning message; detecting a current performance value from the projection device; judging whether the detected current performance value exceeds the predetermined performance threshold; projecting the warning message.

### BRIEF DESCRIPTION OF THE DRAWINGS

FIG. 1 is a functional diagram of a projection device including a warning apparatus for reducing the risk of damage thereto, according to an exemplary embodiment.

FIG. 2 is a flow chart of a warning method, according to the exemplary embodiment.

### DETAILED DESCRIPTION OF THE EMBODIMENTS

Embodiments of the present embodiments will now be described in detail with reference to the drawings.

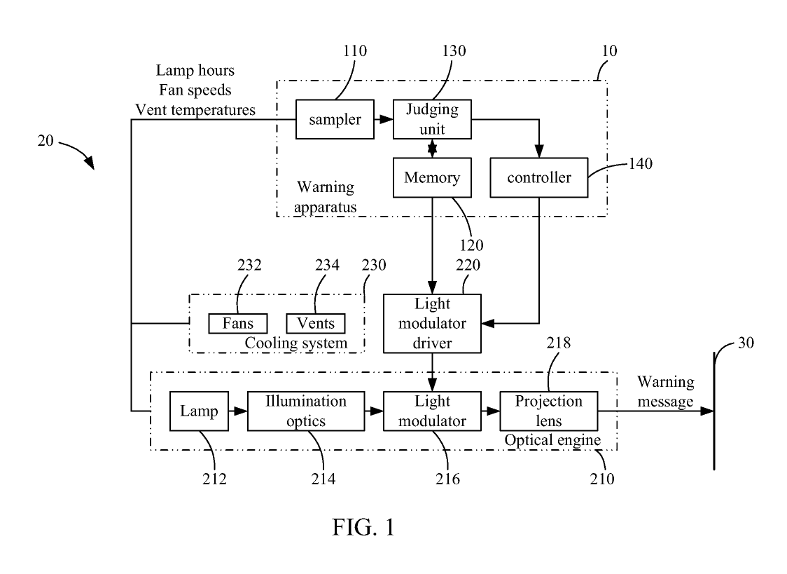

Referring to FIG. 1, a warning apparatus 10 in accordance with an exemplary embodiment is configured to reduce the risk of damage to a projection device 20 such as a digital light processing (DLP), liquid crystal display (LCD), or liquid crystal on silicon (LCOS) projector, which typically includes an optical engine 210 that includes a light modulator 216, e.g., a digital micro-mirror device (DMD), LCD panel, or LCOS panel, configured for light modulation, a light modulator driver 220, a cooling system 230, and a housing (not shown). The optical engine 210 and the light modulator driver 220 are configured to create an image on a screen 30 or the like. In particular, in addition to the light modulator 216, the optical engine 210 further includes a lamp 212, a number of illumination optics 214, and a projection lens 218. The lamp 212 such as a high pressure mercury, metal halide, or xenon lamp, is configured to generate light. The illumination optics 214 are configured to collect light from the lamp 212 to produce illumination. The light modulator driver 220 is configured to drive the light modulator 216 to modulate light from the illumination optics 214 into a visual image based on input signals. The projection lens 218 is configured to project the generated visual image onto the screen 30. The cooling system 230 is configured for heat dissipation of the projection device 20. Particularly, the cooling system 230 includes a number of fans 232 and vents 234 (air inlet or outlet) defined in the housing. The fans 232 are configured to establish air flow, thereby exchanging hot air generated by, e.g., the lamp 212, the light modulator 216, and the light modulator driver 220, inside the housing with cooler air outside the housing via the vents 234. The housing is configured to house the constituent components of the projection device 20 (e.g., the optical engine 210 and the light modulator driver 220).

The warning apparatus 10 includes a sampler 110, a memory 120, a judging unit 130, and a controller 140. The sampler 110 is configured to detect current performance value/s of one or more functions of the projection device 20, e.g., cumulative hours of operation of the lamp 212, speeds of the fans 232, air temperatures at the vents 234 etc. The memory 120 is configured for storing one or more predetermined performance thresholds, e.g., time, speed, and temperature thresholds, and one or more warning messages corresponding to the one or more functions. The judging unit 130 is configured to judge whether any of the detected current performance values exceed the corresponding predetermined performance threshold. The controller 140 is configured to control the light modulator driver 220 to read the warning message and drive the optical engine 210 to display the warning message such as ‘temperature is too high!’ or ‘fan is not working properly!’ on the screen 30 if the detected current performance value exceeds its predetermined threshold.

Furthermore, the memory 120 also can function as the system memory of the projection device 20 to buffer input video/television data, and the controller 140 can act as the central controller of the projection device 20 for controlling various functions of the projection device 20.

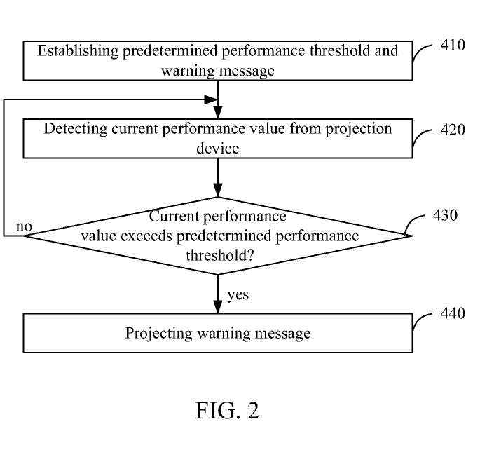

Referring to FIG. 2, a warning method for reducing the risk of damage to a projection device includes the following operations 410˜440.

Operation 410: establishing a predetermined performance threshold and a warning message. In particular, this can be carried out by the manufacturer. For example, the manufacture writes a fan speed threshold, and a text message ‘fan is not working properly’ to the memory 120.

Operation 420: detecting a current performance value from a projection device. For example, the sampler 110 detects the current fan speed of the fans 232 of the projection device 20.

Operation 430: judging whether the detected current performance value exceeds the predetermined performance threshold. The judging unit 130 carries this out. For instance, the judging unit 130 judges whether the detected current fan speed exceeds the fan speed threshold.

Operation 440: projecting the warning message on a screen if the detected current performance value exceeds the predetermined performance threshold. Specifically, the controller 140 controls the light modulator driver 220 to read the text message from the memory 120 and drive the optical engine 210 to create an image containing the warning text such as ‘fan is not working properly’ on the screen 30.

This warning method and apparatus warn users with the warning message by displaying it on the screen, where the users attentions are already focused, thereby conveniently and efficiently warning the users to take action thus preventing damage to the projector.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A warning method for reducing the risk of damage to a projection device, comprising:
establishing a predetermined performance threshold and a warning message;
detecting a current performance value from the projection device;
judging whether the detected current performance value exceeds the predetermined performance threshold;
projecting the warning message if the detected current performance value exceeds the predetermined performance threshold.

2. The warning method as claimed in claim 1, wherein the detected current performance value is cumulative hours of operation of a lamp of the projection device.

3. The warning method as claimed in claim 1, wherein the detected current performance value is a speed value of a fan of the projection device.

4. The warning method as claimed in claim 1, wherein the detected current performance value is a temperature value measured at a vent of the projection device.

5. A warning apparatus for reducing the risk of damage to a projection device, comprising:
a sampler for detecting a current performance value from the projection device;
a memory for storing a predetermined performance threshold and a warning message;
a judging unit for judging whether the detected current performance value exceeds the predetermined performance threshold; and
a controller for controlling the projection device to project the warning message if the detected current performance value exceeds the predetermined threshold.

6. The warning apparatus as claimed in claim 5, wherein the detected current performance value is cumulative hours of operation of a lamp of the projection device.

7. The warning apparatus as claimed in claim 5, wherein the detected current performance value is a speed value of a fan of the projection device.

8. The warning apparatus as claimed in claim 5, wherein the detected current performance value is a temperature value measured at a vent of the projection device.
